(19) United States
(12) Patent Application Publication
(10) Pub. No.: US 2015/0310129 A1
(43) Pub. Date: Oct. 29, 2015

(54) METHOD OF MANAGING DATABASE, MANAGEMENT COMPUTER AND STORAGE MEDIUM

(71) Applicant: HITACHI, LTD., Chiyoda-ku, Tokyo (JP)

(72) Inventor: Kazutomo USHIJIMA, Tokyo (JP)

(73) Assignee: Hitachi, Ltd., Chiyoda-ku, Tokyo (JP)

(21) Appl. No.: 14/649,650

(22) PCT Filed: Jan. 9, 2013
(86) PCT No.: PCT/JP2013/050178

§ 371 Date: Jun. 4, 2015

(51) Int. Cl. G06F 17/30

(52) U.S. Cl. CPC G06F 17/30958; G06F 17/30595; G06F 17/30498

(57) ABSTRACT

The present invention is a method of managing a database, which manages a graph database and a relational database on a computer provided with a processor and memory, wherein the computer acquires frequency of reference for each type of node of a graph database, extracts types of nodes for which the reference frequency is greater than or equal to a threshold, converts the extracted nodes to a table structure, and then retains the same as an intermediate table, and upon receiving an inquiry by the relational database, references the intermediate table.

### BACKGROUND

This invention relates to a technology for efficiently accessing data stored in a graph database by using a relational database interface.

A big advantage of a graph database is a capability to store data for expressing complex relationships as is, such as human relationships in a social network or a delivery state across a logistics network, and flexibility in not needing a schema design before storage unlike a relational database.

In a relational database, complex search and analysis processing can be carried out on data stored in a database by using query requests called Structured Query Language (SQL) (e.g., “SQL Super Text”, by Kosaku Yamahira, Masashi Tsuchida, and Takashi Kotera, published by Gijutsu-Hyohron Co., Ltd., March 2004). Also in a graph database, complex processing can be carried out by using query requests called SPARQL Protocol and RDF Query Language (SPARQL) (e.g., “Programming the Semantic Web”, by Toby Segaran, Colin Evans, and Jamie Taylor, published by O'Reilly 86 Associates Inc, July 2009).

However, current business systems are typically built by using a relational database, and the data of a large number of business systems is stored and utilized in relational databases. Consequently, there has been a problem in that it has not been possible to search or analyze the data stored in a graph database together with the data stored in a relational database.

### SUMMARY

To solve this problem, the data stored in a relational database (RDB) and the data stored in a graph database may be combined by a higher level program that accesses the databases. Alternatively, a table for storing the data stored in the graph database may be separately prepared on the relational database side, the data stored in the graph database may be extracted based on the prepared table by using SPARQL, and the extracted data may be re-stored in the relational database.

However, there has been a problem in that the higher level program needs to be redeveloped each time the method of combining the graph database with the relational database is changed. Further, there has also been a problem in that time and cost is required to prepare a SPARQL query for extracting the data stored in the graph database and to migrate the data.

In view of those problems, it is an object of this invention to efficiently search and analyze data stored in a graph database together with data stored in a relational database.

A representative aspect of this invention is as follows. A database management method for managing a graph database and a relational database in a computer comprising a processor and a memory, the database management method comprising: a first step of acquiring, by the computer, a reference frequency for each type of node in the graph database; a second step of extracting, by the computer, the types of nodes having a reference frequency equal to or more than a threshold; a third step of converting, by the computer, the extracted nodes into a table structure and storing the table structure as an intermediate table; and a fourth step of referencing, by the computer, the intermediate table based on a received query to the relational database.

Therefore, according to the one embodiment of this invention, by defining a correspondence between the data stored in the graph database and the data stored in the relational database, combined search and analysis of both sets of data can be executed using an interface for the relational database. Further, by generating intermediate table data by referencing reference statistical information about the data stored in the relational database and the data stored in the graph database, both the relational database and the graph database can be efficiently searched.

### BRIEF DESCRIPTION OF THE DRAWINGS

FIG. 1 is a block diagram illustrating an example of a computer system according to an embodiment of this invention.

FIG. 2 is a block diagram illustrating an outline of processing performed by the front-end computer according to the embodiment of this invention.

FIG. 3 is a flowchart illustrating an outline of processing performed by the computer system according to the embodiment of this invention.

FIG. 4 is a graph showing the organization of a university in the graph database according to the embodiment of this invention.

FIG. 5 is a graph showing the syllabus of the university in the graph database according to the embodiment of this invention.

FIG. 6 shows a student evaluation table in a relational database according to the embodiment of this invention.

FIG. 7 is a flowchart illustrating a subroutine performed in Step S1 of FIG. 3 according to the embodiment of this invention.

FIG. 8 is an explanatory diagram graphically representing an example of the overall association between the node types and the column types of the graph database and the relational database to be searched according to the embodiment of this invention.

FIG. 9A is a screen for setting the nodes of the university organization graph in the graph database according to the embodiment of this invention.

FIG. 9B is a screen for setting the nodes of the syllabus graph in the graph database according to the embodiment of this invention.

FIG. 9C is a screen for setting the columns of the relational database according to the embodiment of this invention.

FIG. 9D is an explanatory diagram of the setting screen for setting the join condition of the nodes according to the embodiment of this invention.

FIG. 10 is a flowchart illustrating an example of processing for acquiring reference statistical information and generating an intermediate table performed by the front-end computer according to the embodiment of this invention.

FIG. 11 is a flowchart illustrating an example of processing for setting the reference statistical information performed by the front-end computer according to the embodiment of this invention.

FIG. 12A shows an example of the query to the graph database received by the query request reception module according to the embodiment of this invention.

FIG. 12B shows an example of the query to the graph database received by the query request reception module according to the embodiment of this invention.

FIG. 12C shows an example of the query to the relational database received by the query request reception module according to the embodiment of this invention.

FIG. 13 shows a case in which the reference count (or the reference frequency) is reflected in the above-mentioned graph representation according to the embodiment of this invention.

FIG. 14A shows reference statistical information storing statistical information relating to nodes according to the embodiment of this invention.

FIG. 14B shows reference statistical information storing statistical information relating to edges according to the embodiment of this invention.

FIG. 15 is a flowchart illustrating an example of processing for determining a high-frequency reference range by the high-frequency reference range determination module according to the embodiment of this invention.

FIG. 16 is a flowchart illustrating an example of processing for generating the intermediate table by the high-frequency reference range determination module according to the embodiment of this invention.

FIG. 17 shows an overall graph according to the embodiment of this invention.

FIG. 18 shows edges of the high-frequency reference range according to the embodiment of this invention.

FIG. 19A is a graph specified as the high-frequency reference range according to the embodiment of this invention.

FIG. 19B is a graph specified as the high-frequency reference range according to the embodiment of this invention.

FIG. 19C is a graph specified as the high-frequency reference range according to the embodiment of this invention.

FIG. 19D is a graph specified as the high-frequency reference range according to the embodiment of this invention.

FIG. 19E is a graph specified as the high-frequency reference range according to the embodiment of this invention.

FIG. 20 shows an example of the inteimediate table according to the embodiment of this invention.

FIG. 21 is a flowchart illustrating an example of processing for setting the reference statistical information performed by the front-end computer according to the embodiment of this invention.

FIG. 22 shows an example of the query request conversion according to the embodiment of this invention.

### DETAILED DESCRIPTION OF THE PREFERRED EMBODIMENT

An embodiment of this invention is now described with reference to the attached drawings.

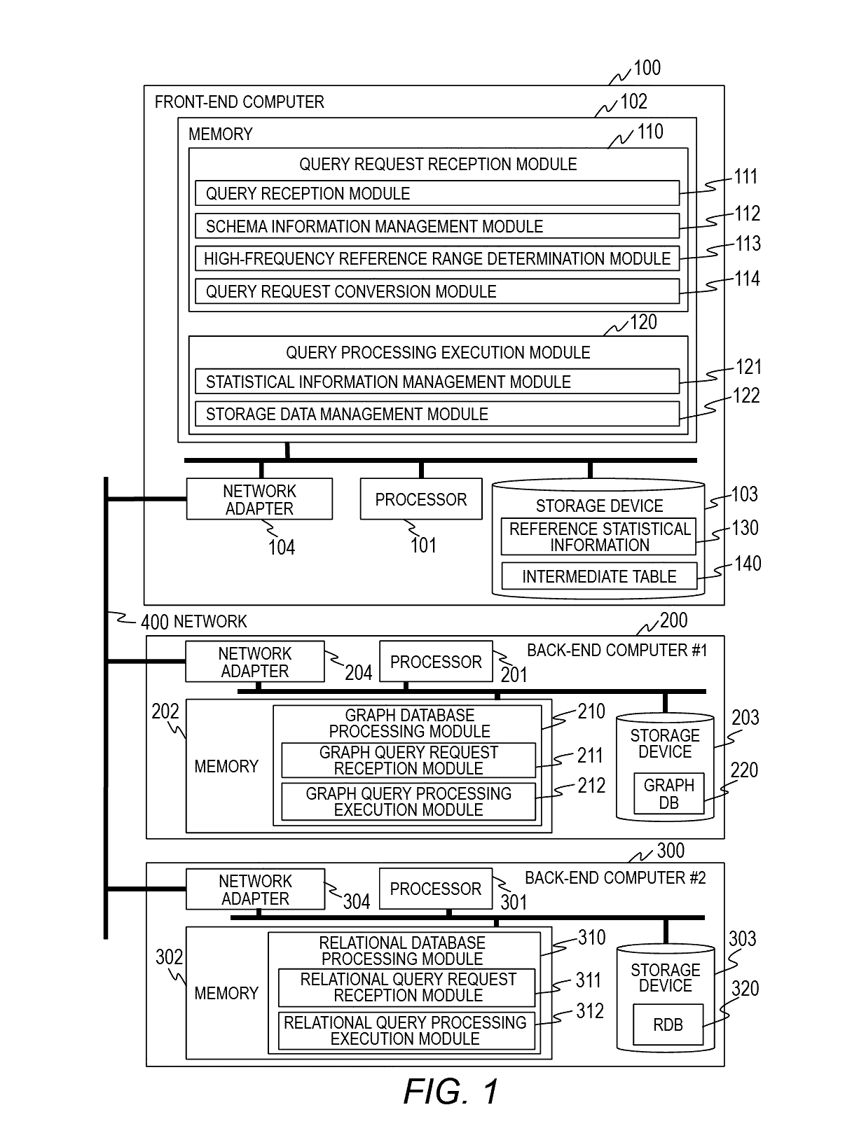

FIG. 1 is a block diagram illustrating an example of a computer system configured to manage a plurality of databases according to an embodiment of this invention.

In FIG. 1, a front-end computer 100 is coupled via a network 400 to a back-end computer 200 configured to manage a graph database and a back-end computer 300 configured to manage a relational database. When the front-end computer 100 receives queries from a computer (not shown) via the network 400, the front-end computer 100 automatically sorts the queries into queries to the relational database and queries to the graph database, and sends the queries to one of the back-end computer 200 and the back-end computer 300. Further, the front-end computer 100 sends a query result from the back-end computers 200 and 300 as a response to the computer (not shown) that sent the query. The front-end computer 100 functions as a management computer configured to manage a graph database 220 and a relational database 320.

The back-end computer (#1) 200 includes a processor 201, a memory 202, a storage device 203, and a network adapter 204. A graph database processing module 210 is loaded in the memory 202 and executed by the processor 201.

The graph database 220 is stored in the storage device 203. The graph database 220 may include log data, media data such as video, images, and documents, unstructured data such as sensing data from a sensor, and the like.

The graph database processing module 210 includes a graph query request reception module 211 configured to receive a query from the front-end computer 100 and a graph query processing execution module 212 configured to execute the received query request and output the query result to the front-end computer 100. Queries to the graph database may employ, for example, SPARQL Protocol and RDF Query Language (SPARQL).

In this case, the processor 201 operates as a function module for realizing a predetermined function by operating based on a program of each function module. For example, by operating based on a graph database processing program, the processor 201 functions as the graph database processing module 210. This is the same for the other programs as well. Further, the processor 201 also operates as a function module for realizing each of a plurality of processes executed by each program. The computer and the computer system are an apparatus and a system including those function modules.

Information about the programs for realizing each function of the graph database processing module 210, tables, and the like may be stored in the storage device 203, a storage device such as a non-volatile semiconductor memory, a hard disk drive, and a solid state drive (SSD), or a computer-readable non-transitory data storage medium such as an IC card, an SD card, and a DVD.

The back-end computer (#2) 300 includes a processor 301, a memory 302, a storage device 303, and a network adapter 304. A relational database processing module 310 is loaded in the memory 302 and executed by the processor 301.

The relational database 320 is stored in the storage device 303. The relational database 320 may include structured data such as a table.

The relational database processing module 310 includes a relational query request reception module 311 configured to receive a query from the front-end computer 100 and a relational query processing execution module 312 configured to execute the received query and output the query result to the front-end computer 100. Queries to the relational database may employ, for example, Structured Query Language (SQL).

In this case, the processor 301 operates as a function module for realizing a predetermined function by operating based on a program of each function module. For example, by operating based on a relational database processing program, the processor 301 functions as the graph database processing module 310. This is the same for the other programs as well. Further, the processor 301 also operates as a function module for realizing each of a plurality of processes executed by each program. The computer and the computer system are an apparatus and a system including those function modules.

Information about the programs for realizing each function of the relational database processing module 310, tables, and the like may be stored in the storage device 303, a storage device such as a non-volatile semiconductor memory, a hard disk drive, and an SSD, or a computer-readable non-transitory data storage medium such as an IC card, an SD card, and a DVD.

The front-end computer 100 includes a processor 101, a memory 102, a storage device 103, and a network adapter 104. A query request reception module 110 and a query processing execution module 120 are loaded in the memory 102 and executed by the processor 101.

The storage device 103 stores, as described below, reference statistical information 130 storing an access state, and an intermediate table (intermediate data) 140 obtained by extracting a part of the graph database processing module 210. It should be noted that the intermediate table 140 may be stored in both the memory 102 and the storage device 103.

The query request reception module 110 includes a query reception module 111 configured to receive a query from a computer (not shown) or a terminal (not shown) via the network 400, a schema information management module 112 configured to manage definitions of structured data, a high-frequency reference range determination module 113 configured to store a range of data having a high access frequency in the graph database 220, and a query request conversion module 114 configured to convert a query to the relational database 320 (e.g., in SQL) into a query to the graph database 220 (e.g., in SPARQL).

The query request reception module 110 is configured to receive queries to the relational database 320 (in SQL etc.) and queries to the graph database 220 (in SPARQL etc.), and command the query processing execution module 120 to execute the queries. Further, if a received query is written in SQL and is to the graph database 220, the query request reception module 110 converts the query into a query to the graph database 220 in SQARQL and the like with the query request conversion module 114, and commands the query processing execution module 120 to execute the query.

The query processing execution module 120 is configured to execute a query to the graph database 220 of the back-end computer 200, to the relational database 320 of the back-end computer 300, or to the intermediate table 140, based on a command from the query request reception module 110.

The query processing execution module 120 includes a statistical information management module 121 configured to generate statistical information about the data on which query processing has been performed as the reference statistical information 130, and update a value relating to the query, and a storage data management module 122 configured to manage the location of data for which the query has been received.

The query processing execution module 120 executes a query to the intermediate table 140 or to the back-end computers 200 and 300 in the manner described below based on the query from the query request reception module 110. The storage data management module 122 manages whether the data to be processed based on the received query is stored in the relational database 320, the graph database 220, or the intermediate table 140.

In this case, the processor 101 operates as a function module for realizing a predetermined function by operating based on a program of each function module. For example, by operating based on a query request reception program, the processor 101 functions as the query request reception module 110. This is the same for the other programs as well. Further, the processor 101 also operates as a function module for realizing each of a plurality of processes executed by each program. The computer and the computer system are an apparatus and a system including those function modules.

Information about the programs for realizing each function of the query request reception module 110 and the query processing execution module 120, tables, and the like may be stored in the storage device 103, a storage device such as a non-volatile semiconductor memory, a hard disk drive, and an SSD, or a computer-readable non-transitory data storage medium such as an IC card, an SD card, and a DVD.

The reference statistical information 130 records the access target and frequency each time the query processing execution module 120 issues a query to the back-end computers 200 and 300. The high-frequency reference range determination module 113 of the query request reception module 110 reads the reference statistical information 130, specifies a range having a high access frequency (high-frequency reference range) in the graph database 220, and extracts the nodes of the high-frequency reference range. Further, after acquiring a correspondence between the graph database 220 and the relational database 320, the high-frequency reference range determination module 113 generates the intermediate table 140 by joining the extracted nodes with the relational database 320 and converting into a table structure. This intermediate table 140 is formed as a table structure, and can be accessed by a relational database query.

Generation of the intermediate table 140 is carried out by, for example, the high-frequency reference range determination module 113. The high-frequency reference range determination module 113 specifies a range having a high access frequency in the graph database 220. Further, the high-frequency reference range determination module 113 extracts the nodes (or the types of nodes) of the graph database 220 in the range specified as having a high access frequency, extracts the relational database 320 corresponding to this range, joins those extracted pieces of data, and converts the joined data into a table structure to be generated as the intermediate table 140. It should be noted that the reference frequency can be calculated from a ratio between the number of times (or the reference frequency) each type of node in the graph database 220 has been referenced and the total number of times the graph database 220 has been accessed. Further, in addition to the storage device 103, the intermediate table 140 can also be stored in a part of the memory 102.

In this case, the high-frequency reference range determination module 113 acquires a correspondence between the relational database 320 and the graph database 220 to be searched, generates a schema (RDB schema 1) having a table structure, and stores the generated schema in the schema information management module 112. It should be noted that a schema (RDB schema 2) for the relational database 320 having a table structure is stored in the schema information management module 112. The schema (RDB schema 2) for the relational database 320 is set when defining or updating the relational database 320.

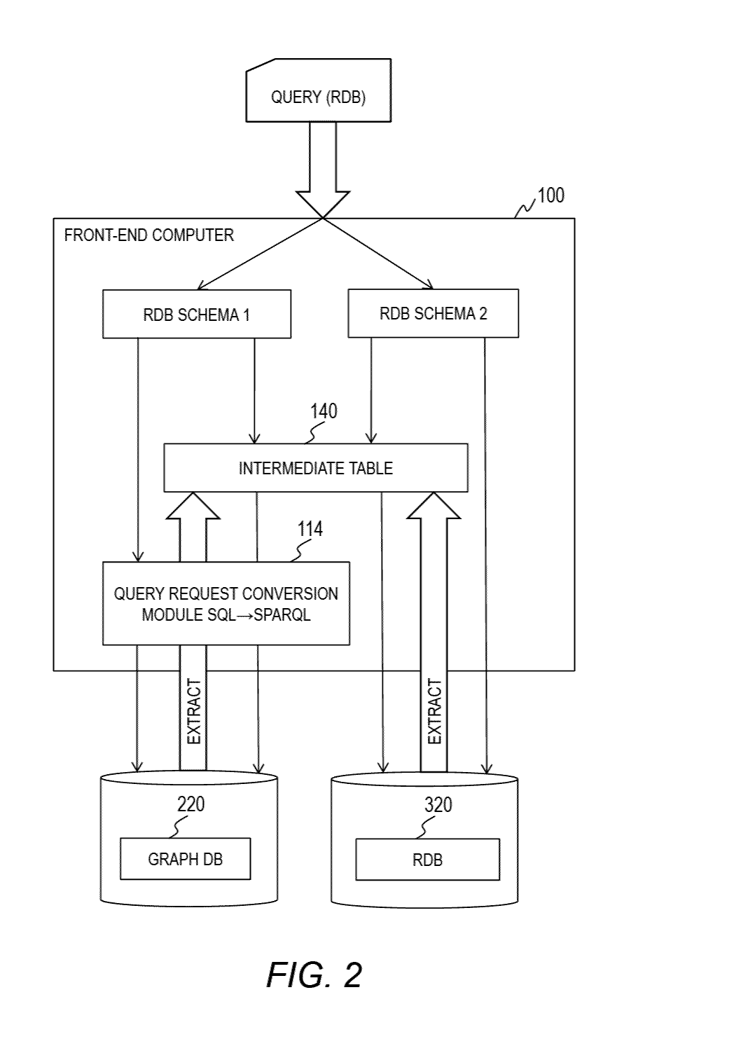

FIG. 2 is a block diagram illustrating an outline of processing performed by the front-end computer 100. The front-end computer 100 receives a query having a table structure or a graph structure from the network 400, and generates the reference statistical information 130 for the referenced data.

Further, the front-end computer 100 generates the intermediate table 140 that has been converted into a table structure by joining a part of the relational database 320 with a part of the graph database 220 based on the reference statistical information 130.

Regarding access of the intermediate table 140, because the intermediate table 140 has a table structure, the elements of the graph database 220 can be accessed by utilizing a query to the relational database 320. Further, because the intermediate table 140 is a table obtained by joining the graph database 220 and the relational database 320, the intermediate table 140 can also be realized by referencing the graph database 220 and the relational database 320 in parallel.

In addition, for data not present in the intermediate table 140, queries are divided into queries to the graph database 220 and queries to the relational database 320, and the queries to the graph database 220 of the back-end computer 200 and the queries to the relational database 320 of the back-end computer 300 are executed in parallel.

In this case, regarding queries to the graph database 220, the query request conversion module 114 can query the back-end computer 200 by converting a query having table structure into a query to the graph database 220. For example, the query request conversion module 114 executes a query to the back-end computer 200 by converting a query (e.g., in SQL) to the relational database (RDB schema 1) into a query to the graph database 220 in SPARQL and the like.

Thus, the front-end computer 100 associates a part of the graph database 220 having a high reference frequency with the relational database 320, and extracts the resultant as the intermediate table 140. When a query is received via the network 400, the intermediate table 140 is accessed based on the schema 1. Only in cases in which the queried data is not present in the intermediate table 140, the query request conversion module 114 accesses the graph database 220 by converting SQL into SPARQL and the like. Further, the relational database 320 can also be accessed in parallel by SQL.

Therefore, when the queried data is in the intermediate table 140, processing can be executed rapidly because the back-end computer 200 and the back-end computer 300 are not accessed.

It should be noted that in FIG. 2, access to the relational database 320 may also be carried out using the RDB schema 2 from a query via the network 400. Further, access to the graph database 220 may also be carried out using the RDB schema 1 from a query via the network 400. In addition, the graph database 220 may also be accessed by receiving a query to the graph database 220 via the network 400.

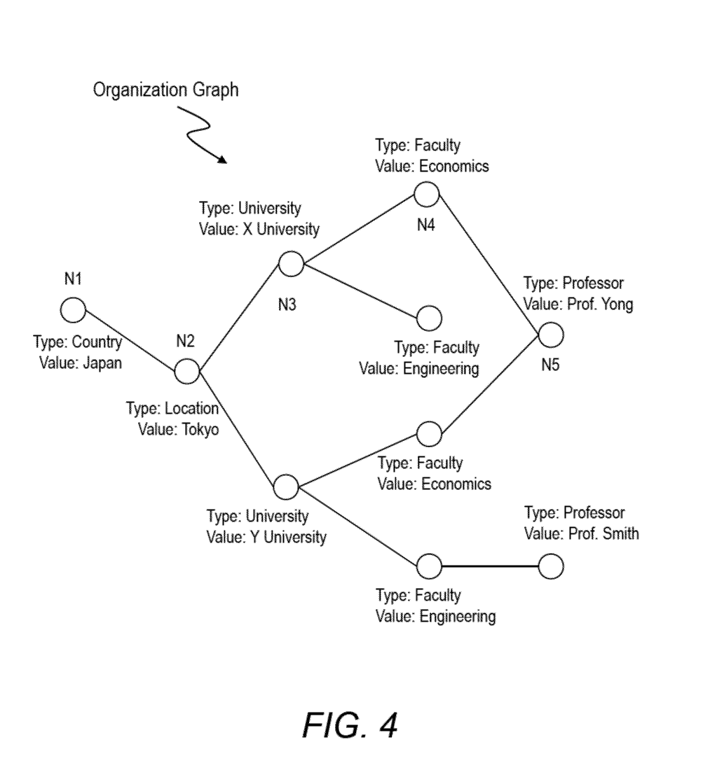

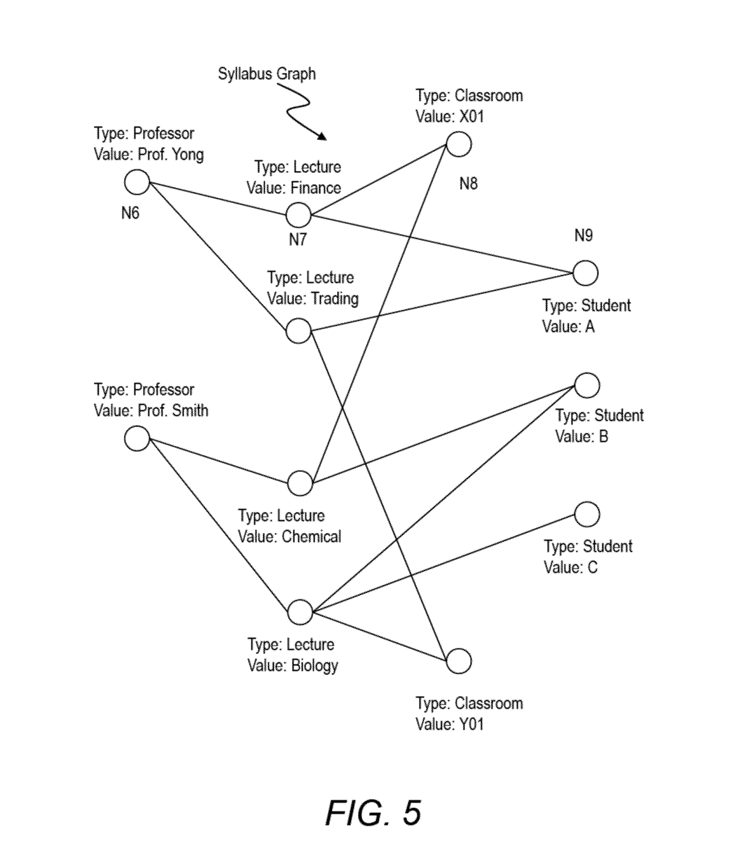

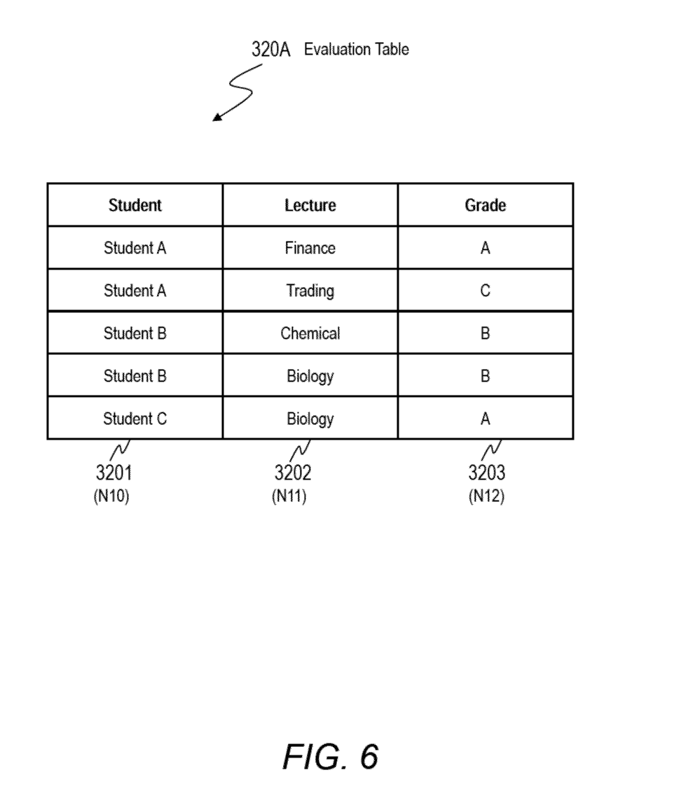

Next, the databases of the back-end computers 200 and 300 are described. FIG. 4 is a graph showing the organization of a university in the graph database 220. FIG. 5 is a graph showing the syllabus of the university in the graph database 220. FIG. 6 shows a student evaluation table 320A in the relational database 320.

The university organization graph shown in FIG. 4 starts from Country N1 as a root node, and tracks back through the nodes Location N2, University N3, and Faculty N4, stopping at the node Professor N5.

The syllabus graph shown in FIG. 5 starts from Professor N6 as a root node, and tracks back through the nodes Lecture N7 and Classroom N8, stopping at the node Student N9.

The evaluation table 320A shown in FIG. 6 is a table including single records each containing a student 3201, a lecture 3202, and a grade 3203. It should be noted that in FIG. 6, the reference numerals N10, N11, and N12 indicate the node names when the fields of the student 3201, the lecture 3202, and the grade 3203 are represented in a graph structure.

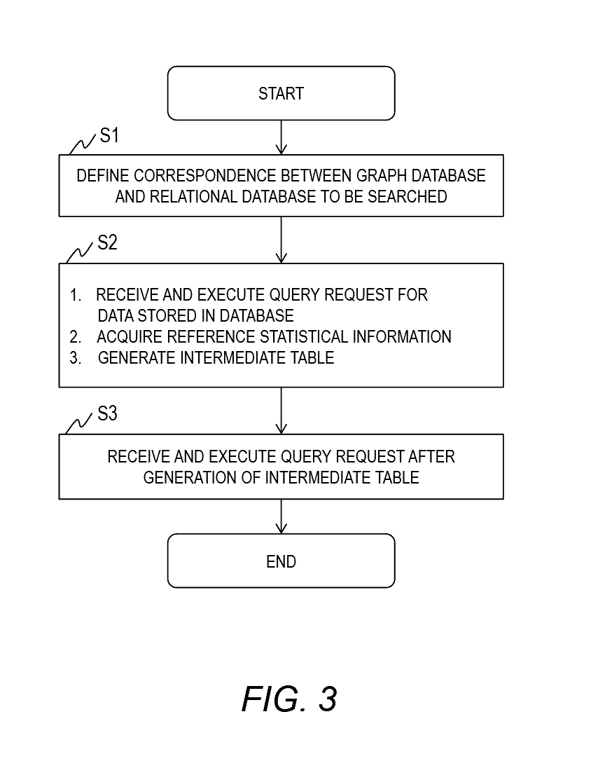

FIG. 3 is a flowchart illustrating an outline of processing performed by the front-end computer 100. This processing starts after the front-end computer 100 is started up. FIG. 3 illustrates processing performed until the intermediate table 140 is generated after receiving a query and accumulating the reference statistical information 130, and a query is received utilizing the intermediate table 140.

First, in Step S1, the front-end computer 100 defines a correspondence between the graph database 220 and the relational database 320 to be searched. For example, the schema information management module 112 of the front-end computer 100 defines the RDB schema 1 by extracting a key associating the values stored in the nodes of the graph database 220 with the values stored in the fields of the relational database 320.

In the examples shown in FIGS. 3 to 6, each lecture in the graph of FIG. 5 is associated with the field of the lecture 3203 in the evaluation table 320A of FIG. 6, and each student in the graph of FIG. 5 is associated with the field of the student 3201 in the evaluation table 320A of FIG. 6.

The schema information management module 112 of the front-end computer 100 stores this correspondence as the RDB schema 1.

Thus, as one example, the fields of the relational database 320 can be defined as having a correspondence with the nodes of the graph database 220 when the field name matches the type of node. As another example, a correspondence may be defined when the name of the field includes a word common to the type of node.

Next, in Step S2, the front-end computer 100 receives a query to a database stored in the back-end computer 200 or 300, and executes access to that database.

When the front-end computer 100 receives a query from a computer (a client etc., not shown) coupled to the network 400, the front-end computer 100 accesses the back-end computer 200 or 300 and executes the query. At this stage, the statistical information management module 121 of the front-end computer 100 accumulates a query history of the nodes of the graph database 220 as reference statistical information 130.

Further, at a predetermined timing, the front-end computer 100 generates the intermediate table 140 by extracting the nodes of the graph database 220 having a high access frequency. Generation of the intermediate table 140 is described later. It should be noted that examples of the predetermined timing include when the front-end computer 100 has received a command to generate the intermediate table 140, at a predetermined cycle, and the like.

Next, in Step S3, when the front-end computer 100 receives a query including access to the graph database 220, such as illustrated in FIG. 2, the front-end computer 100 accesses the intermediate table 140 via the RDB schema 1. Then, when there is a query result in the intermediate table 140, the front-end computer 100 sends the query result from the intermediate table 140 as a response to the computer (not shown) on the network 400. On the other hand, when there is no query result in the intermediate table 140, the front-end computer 100 executes a query to the back-end computers 200 and 300, and accesses the graph database 220 and the relational database 320.

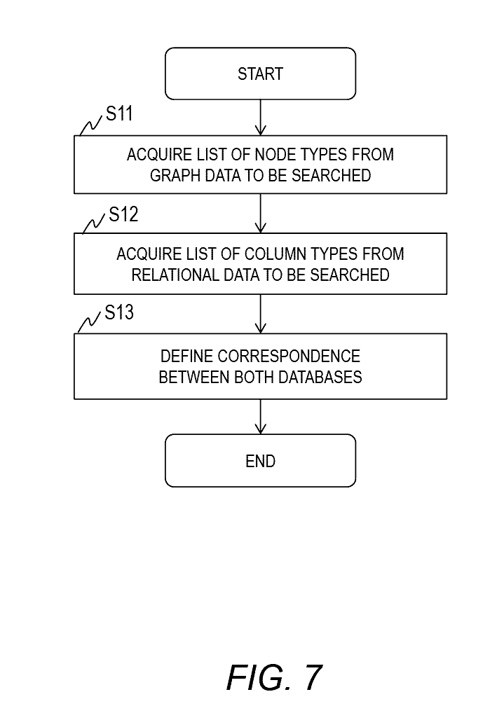

FIG. 7 is a flowchart illustrating a subroutine performed in Step S1 of FIG. 3. This processing can be performed by the schema information management module 112 of the front-end computer 100.

First, in Step S11, the schema information management module 112 acquires a list of the types of nodes included in the graph from the graph database 220 of the back-end computer 200 to be searched.

Next, in Step S12, the schema information management module 112 acquires a list of the types of columns (names of the fields) from the relational database 320 of the back-end computer 300 to be searched.

Then, in Step S13, as described above, the schema information management module 112 defines that the fields of the relational database 320 have a correspondence with the nodes of the graph database 220 for the types of column (the field name) that match the types of node.

Based on the above-mentioned subroutine, the elements included in the RDB schema 1 are generated by extracting a correspondence between the nodes of the graph database 220 and the fields (columns) of the relational database 320.

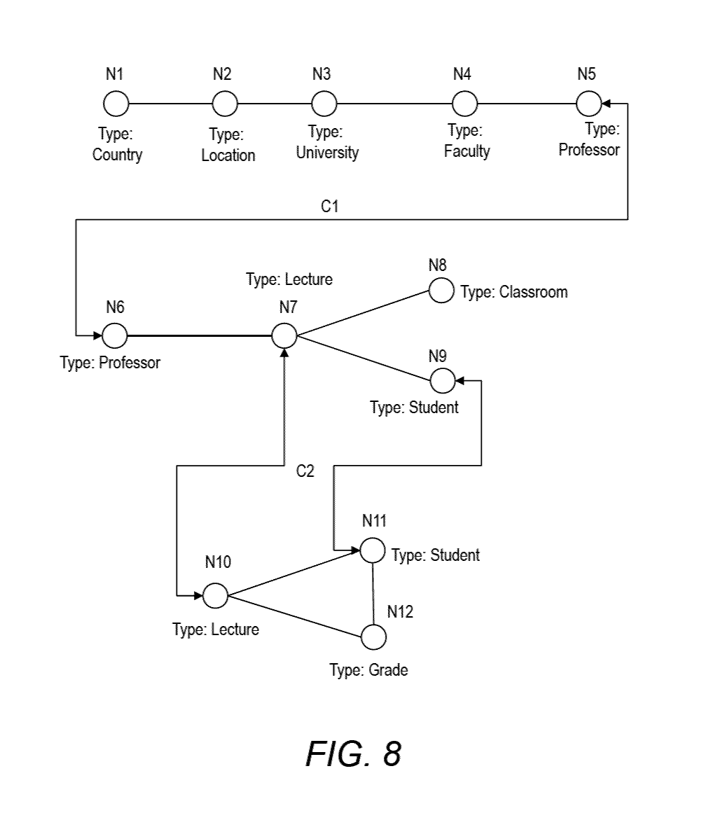

FIG. 8 is an explanatory diagram graphically representing an example of the overall association between the node types and the column types of the graph database and the relational database to be searched.

In FIG. 8, Type: Country N1 to Type: Professor N5 represent the types of nodes included in the graph of the organization of the university shown in FIG. 4. Further, Type: Professor N6 to Type: Student N9 in FIG. 8 represent the types of nodes included in the graph of the syllabus of the university shown in FIG. 5. In addition, Type: Lecture N10 to Type: Grade N12 in FIG. 8 represent the column types of the student evaluation table 320A shown in FIG. 6 in graph form as the nodes Student N10, Lecture N11, and Grade N12.

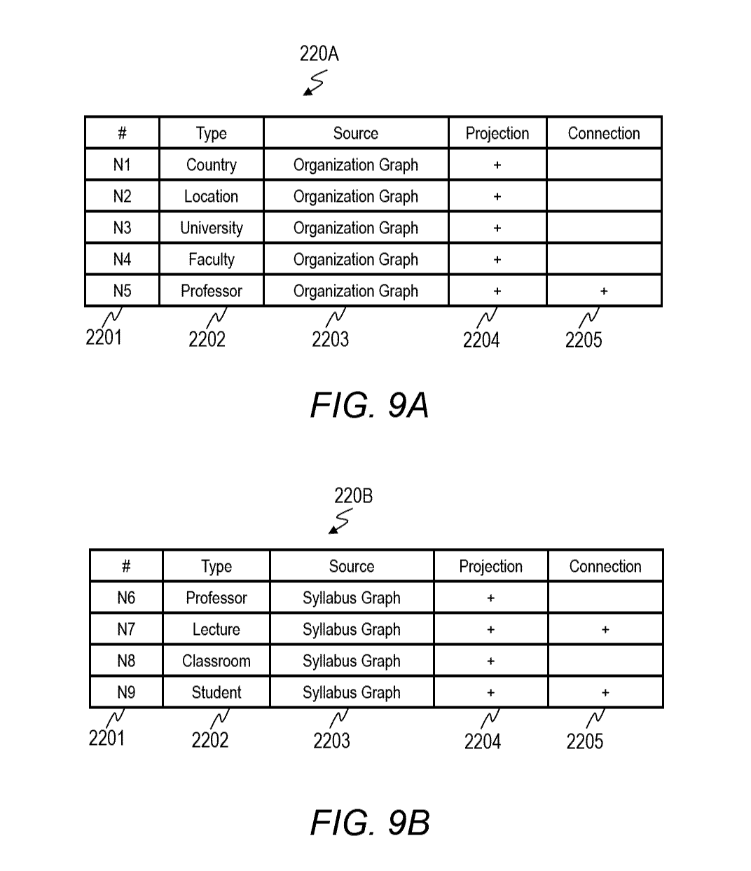

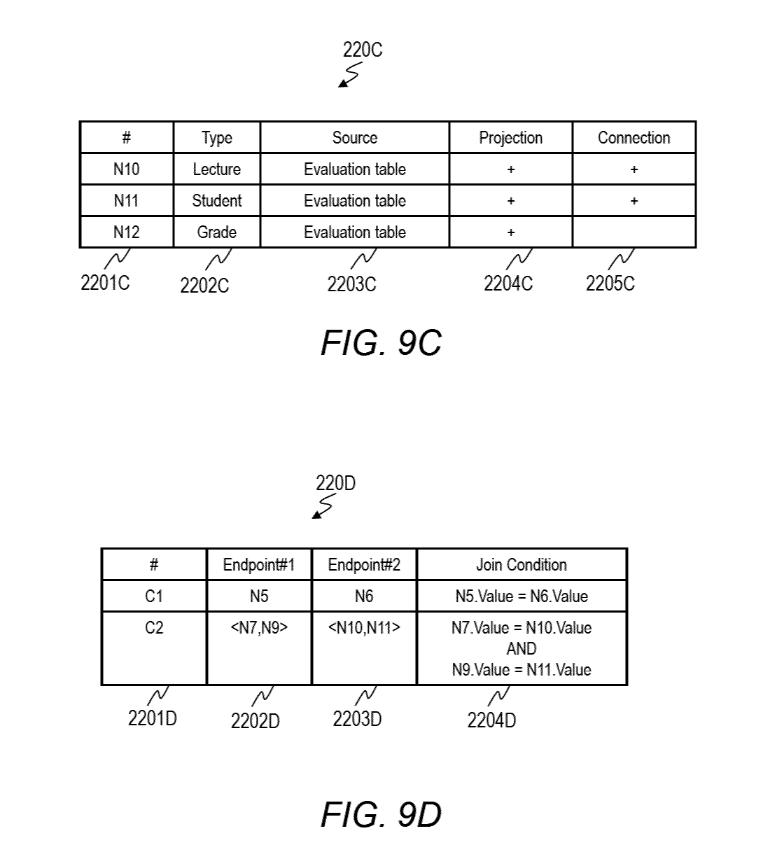

Further, FIG. 8 shows an example of join conditions C1 and C2 set on a setting screen 220D of FIG. 9D described later. In this case, the join condition C1 joins the graph of FIG. 5 with the graph of FIG. 4 when the value for the type: Professor N5, which is the node at end point #1 of the graph of FIG. 4, is the same as the value for the type: Professor N6, which is the root (end point #2) node of the graph of FIG. 5.

On the other hand, the join condition C2 joins the graph representation of FIG. 6 with the graph of FIG. 5 when the value for the type: Professor N5, which is the node at end point #1 of the graph of FIG. 5, matches the value for the node N10 in FIG. 6, and, when the value for the type: Student N9 in the graph of FIG. 5, matches the value for the node N12 in FIG. 6.

In such a manner, in this invention, by temporarily representing the types of columns in the relational database 320 graphically, the correspondence between the graph database 220 and the relational database 320 can be extracted.

FIGS. 9A to 9D are explanatory diagrams each showing an example of a screen defining a correspondence between the graph database 220 and the relational database 320. The screens defining a correspondence between the graph database 220 and the relational database 320 are output to a display device of a terminal (not shown) coupled to the front-end computer 100. An administrator and the like inputs from an input device (not shown) the nodes for which a correspondence is to be set from those screens.

FIG. 9A is a screen for setting the nodes of the university organization graph in the graph database 220. This setting screen 220A has a table structure, for example. One entry includes a number (#) 2201 storing the node number, a type 2202 storing the type of node, a source 2203 storing the database name of an extraction source, a projection 2204 setting whether or not projection is required, and a connection 2205 setting whether or not to join the node with another database.

The administrator and the like using the setting screen 220A operates the input device to input “+” in the projection 2204 when projection is required. It should be noted that “+” only needs to be set for the nodes or columns utilizing projection. Further, “+” is set in the connection 2205 for the nodes to be joined with another database. In the example shown in FIG. 9A, “+” is set so that the node having the node number 2201 “N5” is joined with another database.

FIG. 9B is a screen for setting the nodes of the syllabus graph in the graph database 220. Similar to the above-mentioned FIG. 9A, this setting screen 220B also has a table structure. In the setting screen 220B, similar to FIG. 9A, one entry includes the number (#) 2201 storing the node number, the type 2202 storing the type of node, the source 2203 storing the database name of the extraction source, the projection 2204 setting whether or not projection is required, and the connection 2205 setting whether or not to join the node with another database.

The administrator and the like using the setting screen 220B operates the input device to input “+” in the projection 2204 when projection is required. Further, “+” is set in the connection 2205 for the nodes to be joined with another database. In the example shown in FIG. 9B, “+” is set so that the nodes having the node numbers 2201 “N7” and “N9” are joined with another database.

FIG. 9C is a screen for setting the columns of the relational database 320. Similar to the above-mentioned FIG. 9A, this setting screen 220C also has a table structure. In the setting screen 220C, similar to FIG. 9A, one entry includes a number (#) 2201C storing the node number corresponding to the column, a type 2202C storing the type of column, a source 2203C storing the database name of the extraction source, a projection 2204C setting whether or not projection is required, and a connection 2205C setting whether or not to join the node with another database.

The administrator and the like using the setting screen 220C operates the input device to input “+” in the projection 2204C when projection is required. Further, “+” is set in the connection 2205C for the nodes to be joined with another database. In the example shown in FIG. 9C, “+” is set so that the node having the node numbers 2201 “N10” and “N11” are joined with another database.

FIG. 9D is an explanatory diagram of the setting screen 220D for setting the join condition of the nodes having “+” set in the connection 2205 or 2205C of FIGS. 9A to 9C.

This setting screen 220D has a table structure, for example. In the setting screen 220D, one entry includes a number (#) 2201D storing the number of the join condition, an endpoint 1 (2202D) storing one of the nodes to be joined, an endpoint 2 (2203D) storing another of the nodes to be joined, and a join condition 2204D storing the join condition.

In FIG. 9D, for a join condition number “C1”, a condition is set for joining the university organization graph and the university syllabus graph when the value of the node N5 is the same as the value of the node N6. This setting is information input by the administrator and the like from the input device (not shown) of the terminal.

Similarly, for a join condition number “C2” in FIG. 9D, a condition is set for joining the graph representation of the relational database 320 with the university syllabus graph when the value of the node N5 is the same as the value of the node N10, and the value of the node N9 is the same as the value of the node N11. Similar to the above-mentioned case, this setting is also information input by the administrator and the like from the input device.

Thus, the front-end computer 100 can define the correspondence between the graph database 220 and the relational database 320 can be defined by extracting the types of nodes and the types of columns of the graph database 220 and the relational database 320, and setting the condition of the graph representation of the nodes and the columns to be joined from the terminal and the like operated by the administrator.

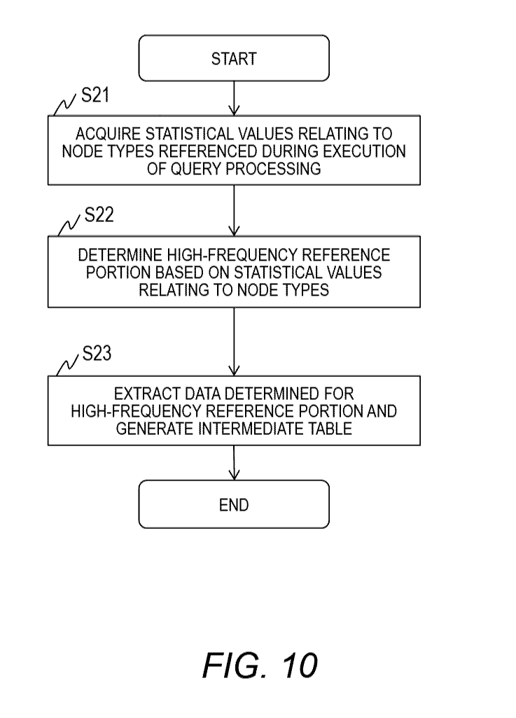

FIG. 10 is a flowchart illustrating an example of processing for acquiring reference statistical information and generating an intermediate table performed by the front-end computer 100. This flowchart is a subroutine illustrating one of the processes performed in Step S2 of FIG. 3. First, in Step S21, the statistical information management module 121 of the front-end computer 100 acquires the reference statistical information 130 for the nodes and edges referenced by execution of a query.

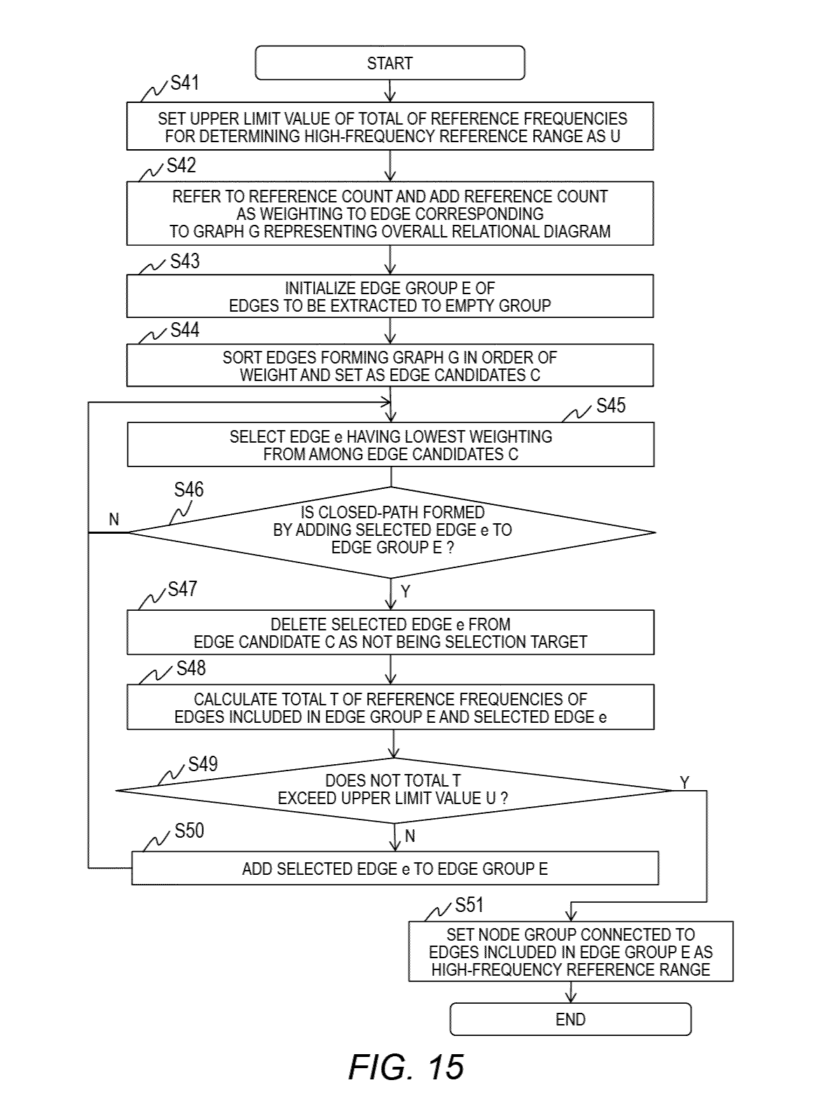

Next, in Step S22, the high-frequency reference range determination module 113 calculates a range of the graph database 220 referenced at a high frequency based on the statistical information relating to the nodes and edges. This processing is described later with reference to FIG. 15 and the like.

In Step S23, the storage data management module 122 extracts the data from the determined high-frequency reference range, and generates the intermediate table 140. This processing is described later with reference to FIG. 15 and the like. It should be noted that the front-end computer 100 executes Step S23 when a command to generate the intermediate table 140 has been received. The front-end computer 100 can skip Step S23 when no command to generate the intermediate table 140 is received.

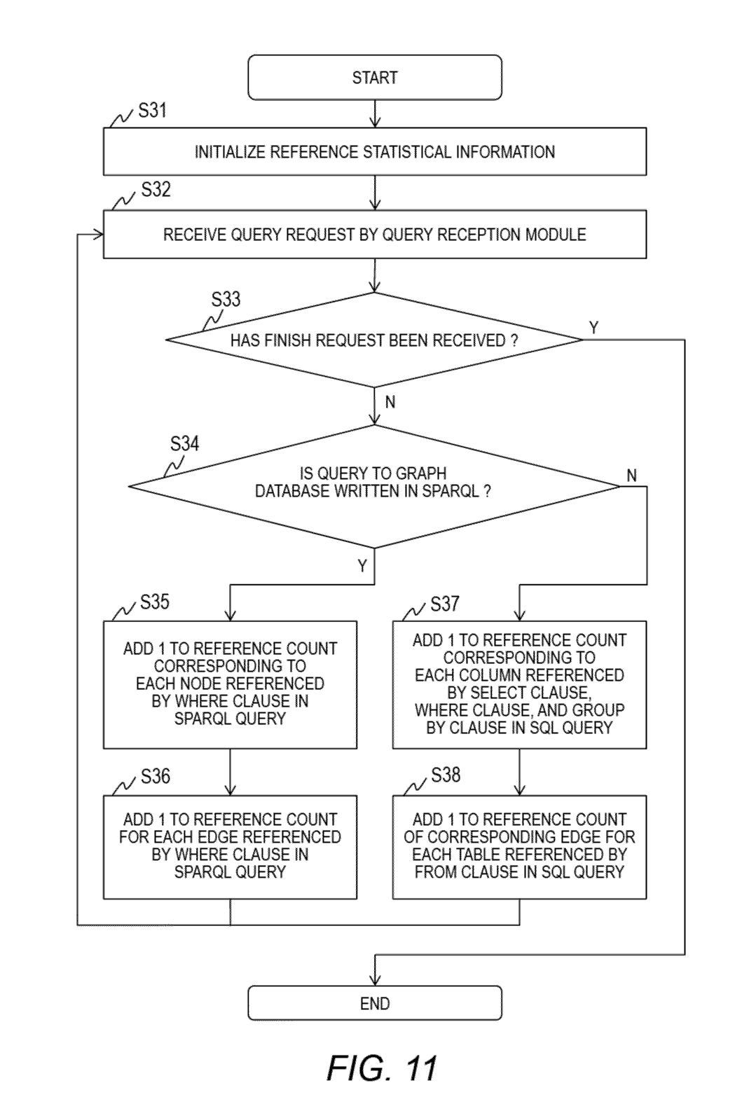

FIG. 11 is a flowchart illustrating an example of processing for setting the reference statistical information 130 performed by the front-end computer 100. This processing is executed after the front-end computer 100 has been started, and is repeatedly executed until a finish request is received.

In Step S31, the statistical information management module 121 performs a predetermined initialization on the reference statistical information 130. Next, in Step S32, the query request reception module 110 receives a query or another request via the network 400.

In Step S33, the query reception module 111 determines whether or not a finish request has been received via the network 400. When a finish request has been received, the processing is finished. On the other hand, when a query has been received, the processing proceeds to Step S34.

In Step S34, the query reception module 111 determines whether or not the received query is a query to the graph database 220 (in SPARQL etc.). When the received query is a query to the graph database 220, the processing proceeds to Step S35. When the received query is a query to the relational database 320, the processing proceeds to Step S37. In this case, the query reception module 111 transmits a query to the statistical information management module 121 and commands that the reference statistical information 130 be updated.

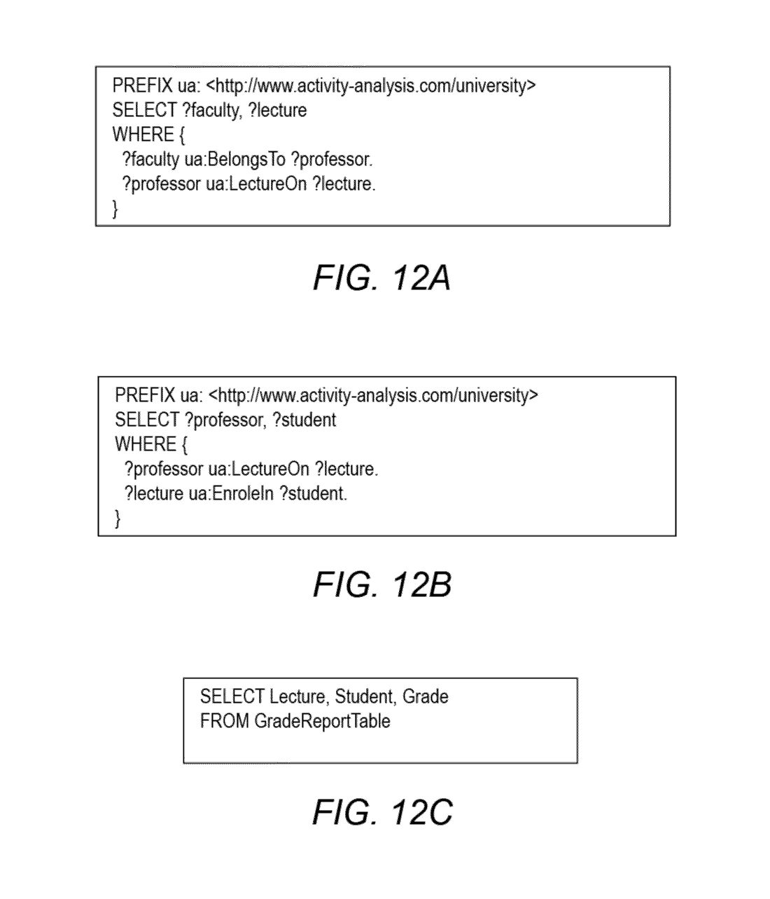

FIGS. 12A to 12C each show an example of a query received by the query request reception module 110. In the examples of FIGS. 12A and 12B, the query to the graph database 220 is written in SPARQL. In the example of FIG. 12C, the query to the relational database 320 is written in SQL.

When the query to the graph database 220 is in SPARQL, in Step S35, the statistical information management module 121 specifies the type of each node referenced by the WHERE clause in the SPARQL query from the reference statistical information 130, and adds 1 to the reference count of that node type. It should be noted that when the relevant node type is not present in the reference statistical information 130, the statistical information management module 121 adds this node type to the reference statistical information 130 and adds 1 to the reference count.

Next, in Step S36, the statistical information management module 121 specifies the type of each edge referenced by the WHERE clause in the SPARQL query from the reference statistical information 130, and adds 1 to the reference count of that edge type. It should be noted that when the relevant edge type is not present in the reference statistical information 130, the statistical information management module 121 adds this edge type to the reference statistical information 130 and adds 1 to the reference count. Then, the processing returns to Step S32, and the query request reception module 110 receives the next query.

When the query to the relational database 320 is in SQL, in Step S37, the statistical information management module 121 specifies the type of each column referenced by the SELECT clause, the WHERE clause, and the GROUP BY clause in the SQL query from the reference statistical information 130, and adds 1 to the reference count of that column type. It should be noted that when the relevant column type is not present in the reference statistical information 130, the statistical information management module 121 adds this column type to the reference statistical information 130 and adds 1 to the reference count.

Next, in Step S38, the statistical information management module 121 specifies each table referenced by the FROM clause in the SQL query from the reference statistical information 130, and adds 1 to the reference count of that table. It should be noted that when the relevant table is not present in the reference statistical information 130, the statistical information management module 121 adds this table type to the reference statistical information 130 and adds 1 to the reference count. Then, the processing returns to Step S32, and the query request reception module 110 receives the next query.

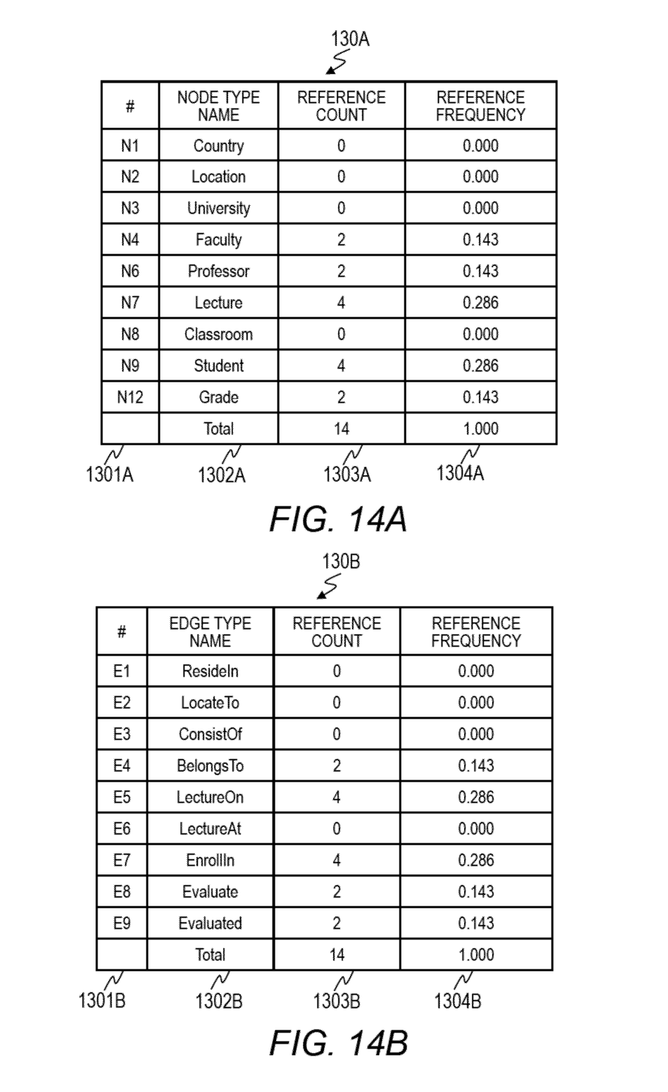

In this case, FIGS. 14A and 14B each show an example of the reference statistical information 130 for managing the reference count. FIG. 14A shows reference statistical information 130A storing statistical information relating to nodes. FIG. 14B shows reference statistical information 130B storing statistical information relating to edges. It should be noted that although the reference statistical information relating to columns and tables is not shown here, such reference statistical information has a similar structure to the reference statistical information 130A and the reference statistical information 130B. The reference statistical information 130A and the reference statistical information 130B are collectively referred to here as reference statistical information 130.

In the reference statistical information 130A shown in FIG. 14A, one record includes a number (#) 1301A storing the node number, a node type name 1302A storing the name of the node type, a reference count 1303A, and a reference frequency 1304A obtained by dividing the reference count by a total. It should be noted that the calculation of the reference frequency 1304A is carried out by the statistical information management module 121 at a predetermined timing, such as during setting of the reference count.

In the reference statistical information 130B shown in FIG. 14B, one record includes a number (#) 1301B storing the edge number, an edge type name 1302B storing the name of the edge type, a reference count 1303B, and a reference frequency 1304B obtained by dividing the reference count by a total. It should be noted that the calculation of the reference frequency 1304B is carried out by the statistical information management module 121 at a predetermined timing, such as during setting of the reference count.

It should be noted that the reference statistical information 130A and the reference statistical information 130B may also be generated by the statistical information management module 121 acquiring the type of node and the like from the graph database 220 during initialization of the statistical information management module 121. Further, as the reference statistical information 130B relating to the edges, reference statistical information 130B in which the edge type names are set in advance may be prepared.

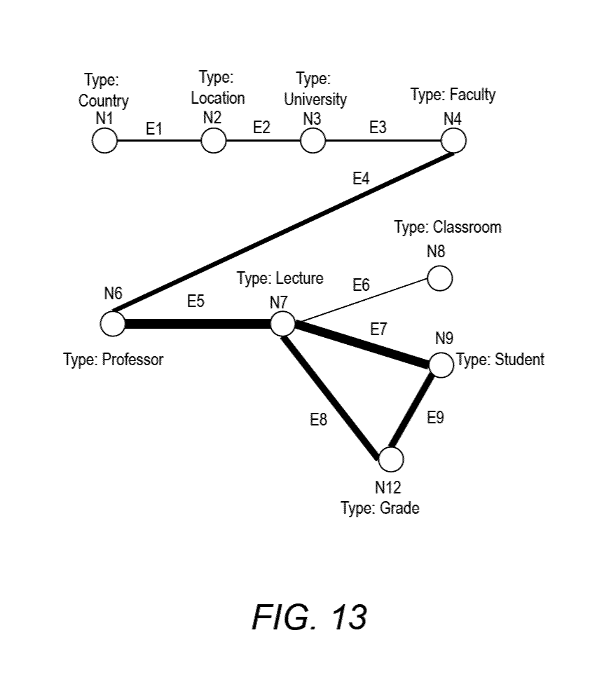

As a result of repeating the above-mentioned processing of FIG. 11, the reference statistical information 130A and the reference statistical information 130B are updated in the manner shown in FIGS. 14A and 14B, and the reference count and reference frequency of the nodes and edges are updated. Further, although not shown, the reference counts of the columns and the tables of the relational database 320 are also updated. In addition, FIG. 13 shows a case in which the reference count (or the reference frequency) is reflected in the above-mentioned graph representation of FIG. 8.

FIG. 13 is a graph representation in which the reference statistical information 130 of FIGS. 14A, 14B, and the like has been added to the graph representation of the overall relational diagram shown in FIG. 8. In FIG. 13, the thickness of the edges in the graph representation is set based on the value of the reference count (or the reference frequency). In FIG. 13, the thickness of the edges is set thicker as the reference count increases. FIG. 13 shows that the reference frequencies for edges E5, E7, and E8 are a high frequency.

FIG. 15 is a flowchart illustrating an example of processing for determining a high-frequency reference range by the high-frequency reference range determination module 113. This processing illustrates a subroutine of the processing performed in Step S22 of FIG. 10.

In Step S41, the high-frequency reference range determination module 113 sets an upper limit value U of a total of the reference frequencies as a value for determining the high-frequency reference range. The upper limit value U is a value set in advance.

In Step S42, the high-frequency reference range determination module 113 acquires the reference count and the reference frequency from the reference statistical information 130, and applies a weighting to the edges of the graph representation of the overall relational diagram of the graph database 220 and the relational database 320 shown in FIG. 13. As shown in FIG. 13, the weighting for the overall relational diagram obtained by joining the graph database 220 and the relational database 320 is set by taking the reference frequency 1304B of the reference statistical information 130B shown in FIG. 14B as the weighting of each edge type name 1302B.

Next, in Step S43, the high-frequency reference range determination module 113 initializes an edge group E, which stores the edges to be extracted, by setting the edge group E as an empty group.

In Step S44, the high-frequency reference range determination module 113 sorts the edges included in a graph G formed by joining the relational database 320 with the graph database 220 shown in FIG. 13 in ascending order of weight, and sets the sorted results as edge candidates C. In other words, the edge candidates C are obtained by sorting the reference statistical information 130B shown in FIG. 14B in ascending order of reference frequency.

Next, in Step S45, the high-frequency reference range determination module 113 selects an edge e having the smallest weighting from among the edge candidates C.

In Step S46, the high-frequency reference range determination module 113 determines whether or not a closed-path is formed when the edge e is added to the edge group E. When a closed-path is not formed, the processing returns to Step S45, and the high-frequency reference range determination module 113 selects the next edge e.

On the other hand, when a closed-path is formed in the edge group E, the processing proceeds to Step S47. In Step S47, the high-frequency reference range determination module 113 determines that the currently selected edge e is not a selection target, and deletes the edge e from the edge candidates C. In this case, the term “closed-path” refers to a path on the graph that returns to the same node as the starting node, with every edge being passed through only once.

In Step S48, the high-frequency reference range determination module 113 calculates a total T of the reference frequencies of the edges included in the edge group E and the selected edge e.

In Step S49, the high-frequency reference range determination module 113 determines whether or not the total T does not exceed the upper limit value U. When the total T is equal to or less than the upper limit value U, the processing proceeds to Step S50. When the total T exceeds the upper limit value U, the processing proceeds to Step S51.

In Step S50, the high-frequency reference range determination module 113 adds the currently selected edge e to the edge group E. Then, the processing returns to Step S45, and the high-frequency reference range determination module 113 processes the next edge e.

On the other hand, in Step S51, because the total T exceeds the upper limit value U, the high-frequency reference range determination module 113 specifies the group of nodes coupled to the edge e included in the edge group E as the high-frequency reference range. In other words, the group of nodes positioned at both ends of the edge e included in the edge group E are specified as the high-frequency reference range.

As a result of the above-mentioned processing, the edge candidates C are obtained by sorting the reference statistical information 130B shown in FIG. 14B in ascending order of the reference frequency 1304B. The edges e are successively selected from the edge candidates C in ascending order of weight, and each edge e that forms a closed-path is added to the edge group E until the total T of the reference frequencies of the edge group E and the edge e exceeds the upper limit value U. Further, the group of nodes coupled to the edges of the edge group E is specified as the high-frequency reference range.

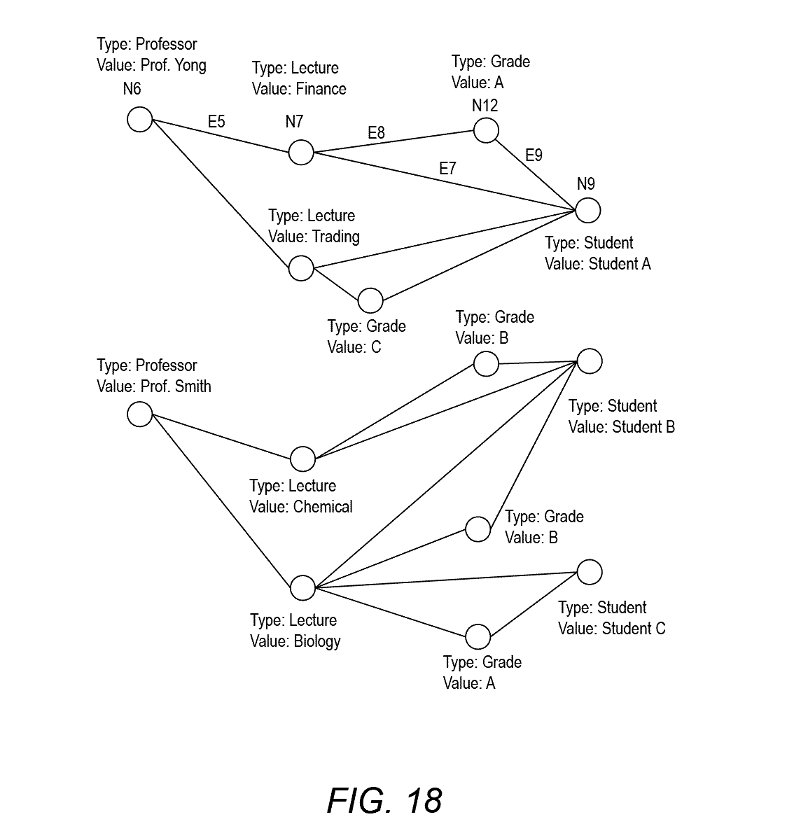

Based on the above-mentioned processing, for example, the edges E5, E7, and E8 shown in FIG. 18 are stored in the edge group E as edges having a high reference frequency, and the nodes N6, N7, N9, and N12 corresponding to those edges are specified as the high-frequency reference range.

It should be noted that in the above-mentioned example, although the upper limit value U is compared with the total T of the reference frequencies, data having a reference count for each type of each node equal to or more than a threshold may also be set as the high-frequency reference range. Alternatively, data having a reference frequency for each type of each node equal to or more than a threshold may also be set as the high-frequency reference range.

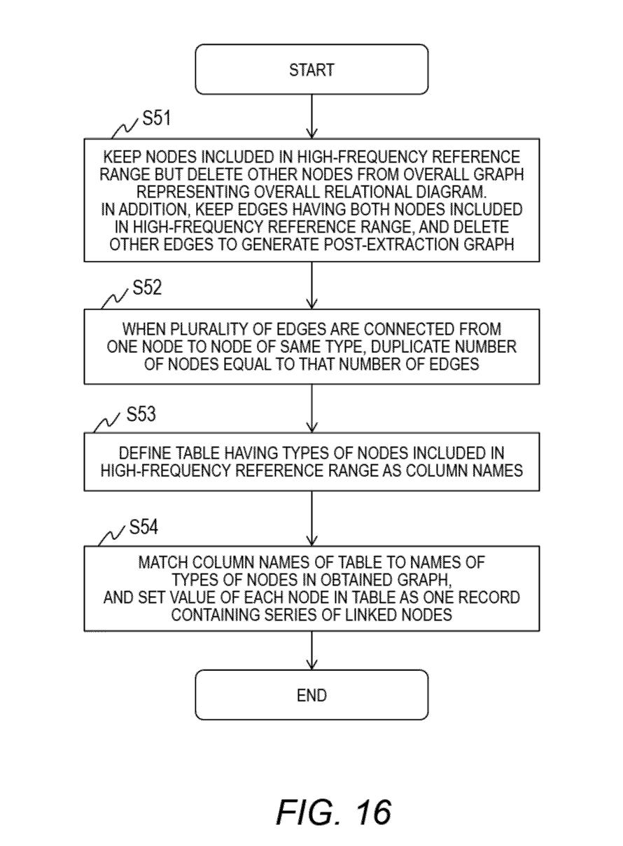

FIG. 16 is a flowchart illustrating an example of processing for generating the intermediate table 140 by the high-frequency reference range determination module 113. This processing is a subroutine of the processing performed in Step S23 of FIG. 10.

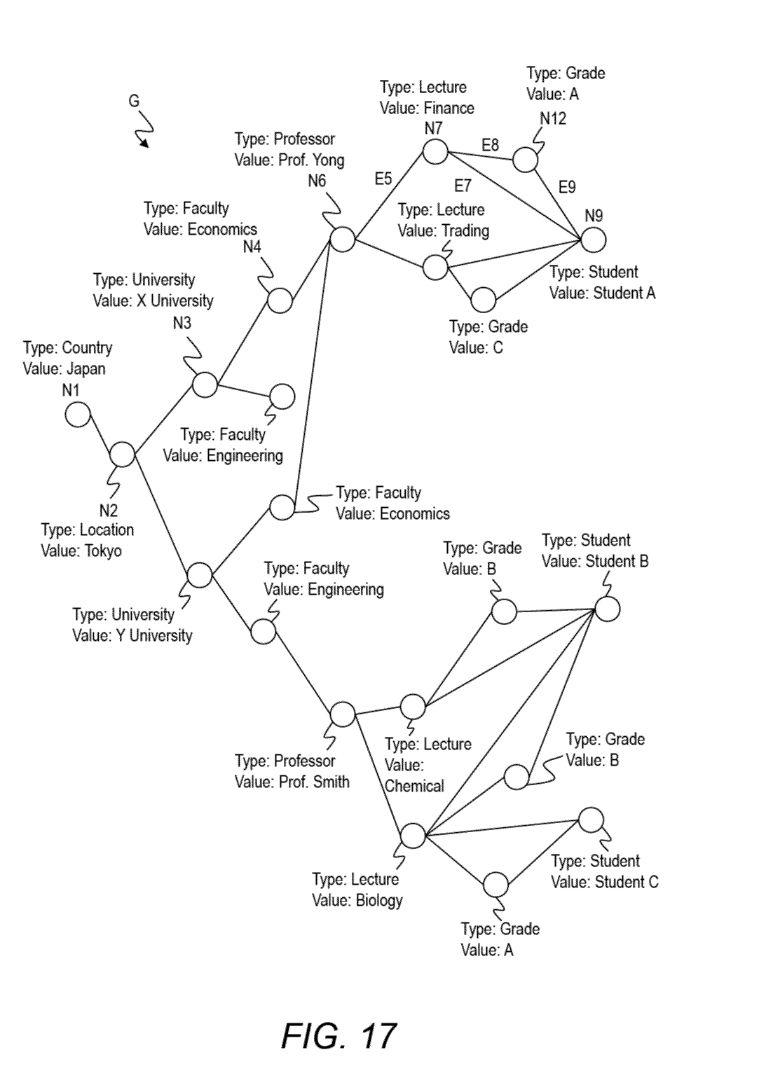

First, in Step S51, the high-frequency reference range determination module 113 references the reference statistical information 130, and keeps the nodes included in the high-frequency reference range but deletes the other nodes from the overall graph G shown in FIG. 17 representing the overall relational diagram of the databases. In addition, the high-frequency reference range determination module 113 keeps the edges having both nodes included in the high-frequency reference range, and deletes the other edges to form a post-extraction graph.

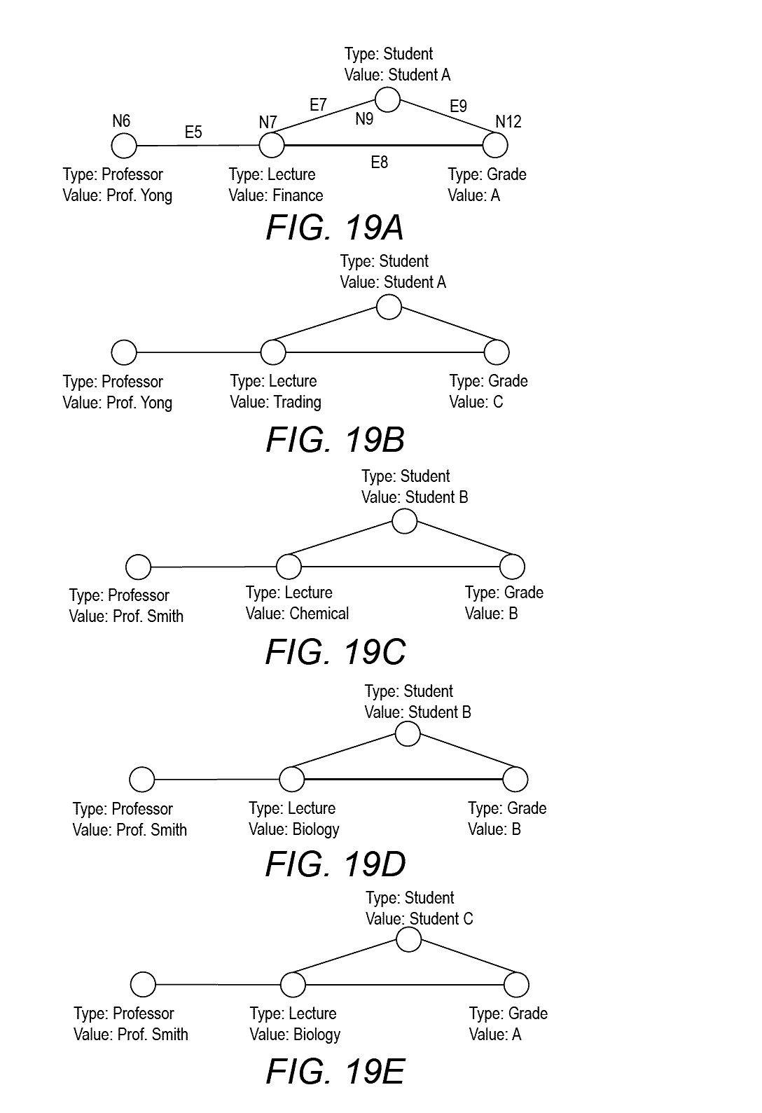

The graph shown in FIG. 18 is obtained by, in the example shown in FIG. 17, keeping the nodes N6, N7, N9, and N12 corresponding to the edges E5, E7, and E8 of the high-frequency reference range, but deleting the nodes N1 to N4 and N8. As a result, nodes such as those shown in FIGS. 19A to 19E are extracted as the high-frequency reference range.

Next, in Step S52, when a plurality of edges are coupled from one node to a node of the same type, the high-frequency reference range determination module 113 duplicates a number of nodes equal to that number of edges.

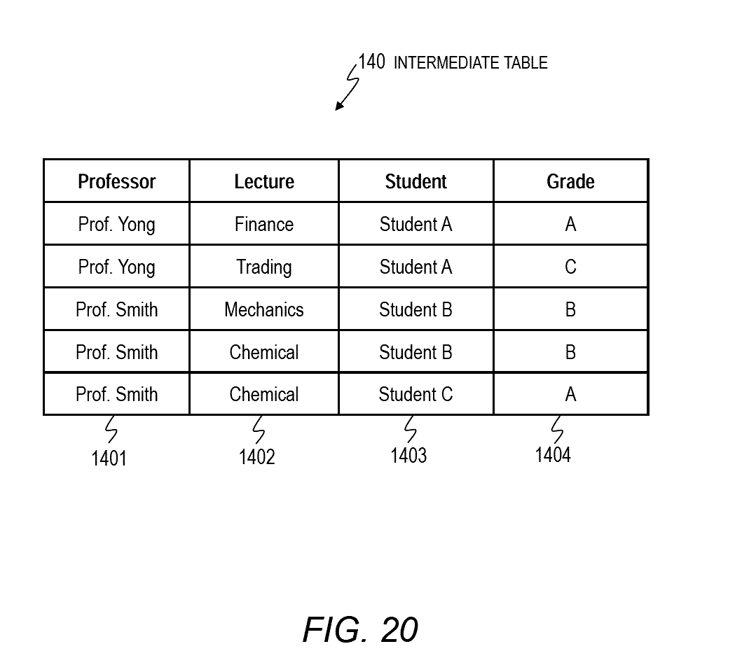

In Step S53, the high-frequency reference range determination module 113 defines a table having the types of nodes included in the high-frequency reference range as column names as the intermediate table 140. In other words, as shown in FIG. 20, the high-frequency reference range determination module 113 defines a table including as one record a professor 1401 column, a lecture 1402 column, a student 1403 column, and a grade 1404 column as the columns of the intermediate table 140.

In Step S54, the high-frequency reference range determination module 113 matches the column names 1401 to 1403 of the intermediate table 140 to the names of the types of nodes in the graphs of FIGS. 19A to 19E specified as the high-frequency reference range, and sets the value of each node in the intermediate table 140 as one record containing the series of nodes linked in FIGS. 19A to 19E.

The intermediate table 140 obtained in this manner has a table structure, which allows a query to the graph database 220 to be accessed with a query to the relational database 320 in SQL and the like by joining the lecture and the student of the graph database 220 with the grade of the relational database 320 having a table structure.

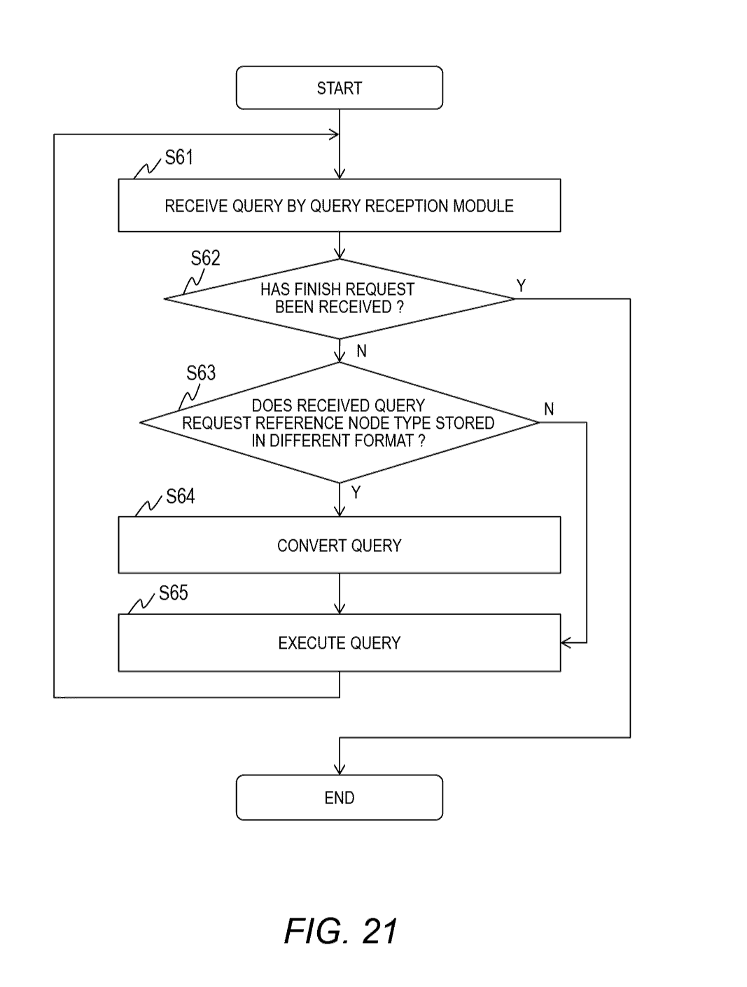

FIG. 21 is a flowchart illustrating an example of processing for setting the reference statistical information 130 performed by the front-end computer 100 after generation of the intermediate table 140. This processing is executed after generation of the intermediate table 140 in place of the processing of FIG. 11, and is repeatedly executed until a finish request is received.

In Step S61, the query reception module 111 of the query request reception module 110 receives a query or another request via the network 400.

In Step S62, the query reception module 111 determines whether or not a finish request has been received via the network 400. When a finish request has been received, the processing is finished. On the other hand, when a query has been received, the processing proceeds to Step S64.

In Step S63, the query reception module 111 determines whether or not the received query is a query capable of utilizing the intermediate table 140. In other words, the act of determining whether or not to reference the type of node in a different format from that of the received query is equivalent to determining whether or not to access the graph database 220 with a query to a database having a table structure, and means determining whether or not to reference the intermediate table 140 obtained by joining the relational database 320 with the graph database 220.

In this determination, when a column of the intermediate table 140 is included in the received query, for example, the processing proceeds to Step S64. In other words, the query reception module 111 references the type of nodes that are in a different format from the received query. On the other hand, when a column of the intermediate table 140 is not included in the received query, the processing proceeds to Step S65. Then, the query reception module 111 executes a query to the graph database 220 or the relational database 320 in the same manner as in FIG. 11.

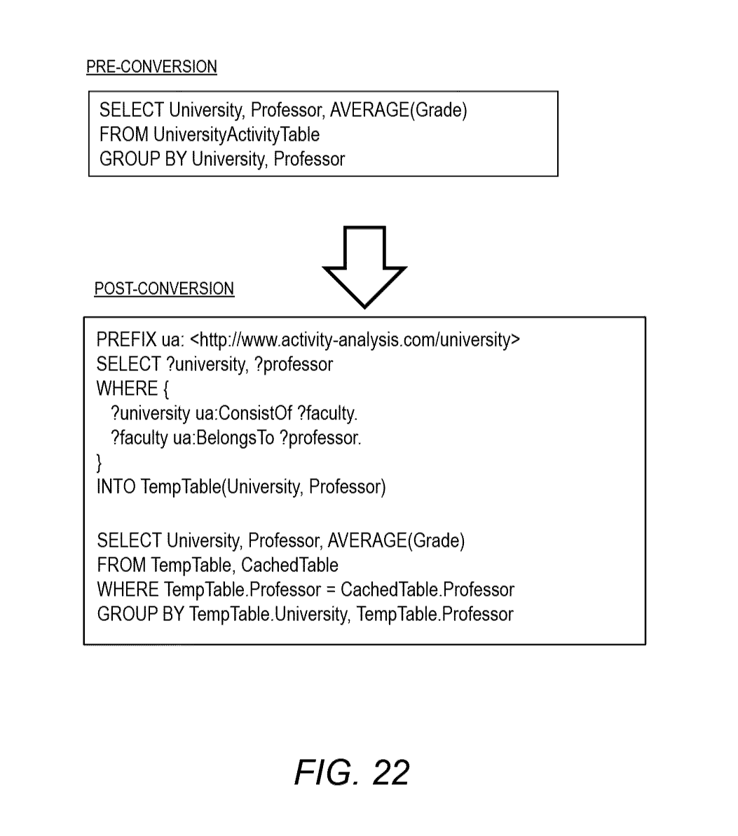

In Step S64, the query request conversion module 114 converts queries to the intermediate table 140 into SQL, and queries to the graph database 220 that are not included in the intermediate table 140 into SPARQL. This conversion is performed as shown in FIG. 22, for example. The pre-conversion query of FIG. 22 is written in SQL, and is a query about University, Faculty, and the average of Grade. In this case, because University and Faculty are not included in the intermediate table 140, the query request conversion module 114 converts the query into SPARQL, and queries the graph database 220. On the other hand, Grade is included in the intermediate table 140, and hence the intermediate table 140 can be accessed by the SQL query as is. “CachedTable”, which is in the post-conversion query in FIG. 22, corresponds to the intermediate table 140.

Then, in Step S65, the intermediate table 140 and the graph database 220 can be accessed by commanding the query processing execution module 120 to execute the query converted by the query request conversion module 114. When execution of the query is complete, the processing returns to Step S61, and the query request reception module 110 receives the next query.

Based on the above-mentioned processing, the frequently-accessed graph database 220 can be referenced with a relational database query by extracting the data having a high access frequency in the graph database 220 as the intermediate table 140, which is a database having a table structure obtained by joining with the relational database 320.

Thus, in this invention, in the graph database 220, the edge group E having a total T of the reference frequencies that does not exceed the upper limit value U is extracted as the data having a high reference frequency, and is converted into the intermediate table 140 having a table structure. As a result, the graph database 220 can be referenced using a query to the relational database 320 to access the intermediate table 140. It should be noted that in the above-mentioned embodiment, although the total of the reference frequencies is compared with the upper limit value U, data having a reference count for each type of node of a predetermined value or more may also be used as the high-frequency reference range.

Further, because the intermediate table 140 is obtained by extracting the data in a high-frequency reference range having a reference frequency equal to or more than a threshold, the frequency of converting queries for the relational database 320 into queries for the graph database 220 is reduced, which allows the graph database 220 to be quickly utilized.

Further, the intermediate table 140 is obtained by joining the relational database 320 with a part of the graph database 220 extracted in the intermediate table 140 based on the correspondence between the graph database 220 and the relational database 320. As a result, the graph database 220 and the relational database 320 can be simultaneously accessed with one query having a table structure, enabling different databases to be efficiently utilized.

Further, when generating the intermediate table 140, the data of the relational database 320 is joined after being converted into graph data. This allows different types of databases to be joined while maintaining the relationships from the root of the graph database 220 to the leaves (end points).

In the above-mentioned embodiment, an example is described in which the query request reception module 110 and the query processing execution module 120 for managing the databases are executed by the front-end computer 100, and the graph database 220 and the relational database 320 are provided by the back-end computers 200 and 300. However, although not shown, those functions may be provided by a single computer.

It should be noted that a part or all of the components in the computer and the like, and the processing modules, the processing units, and the like described in this invention may also be realized using dedicated hardware.

Further, the various software (programs) exemplified in the above-mentioned embodiment may be stored on various types of recording media (e.g., non-transitory computer-readable storage media), such as electromagnetic recording media, electronic recording media, and optical recording media, or alternatively, may be downloaded to a computer via a communication network such as the Internet.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

What is claimed is:

1. A database management method for managing a graph database and a relational database in a computer comprising a processor and a memory, the database management method comprising:
a first step of acquiring, by the computer, a reference frequency for each type of node in the graph database;
a second step of extracting, by the computer, the types of nodes having a reference frequency equal to or more than a threshold;
a third step of converting, by the computer, the extracted nodes into a table structure and storing the table structure as an intermediate table; and
a fourth step of referencing, by the computer, the intermediate table based on a received query to the relational database.

2. The database management method according to claim 1, wherein the third step comprises:
acquiring a correspondence between the graph database and the relational database; and
joining the relational database with the nodes converted into the table structure based on the correspondence.

3. The database management method according to claim 2, wherein the fourth step comprises referencing, based on the received query to the relational database, the relational database joined with the nodes extracted from the graph database.

4. The database management method according to claim 1, wherein the fourth step comprises:
converting, when data corresponding to the query to the relational database is not present in the intermediate table, the query to the relational database into a query to the graph database; and
referencing the graph database with the converted query to the graph database.

5. The database management method according to claim 2, wherein the joining the relational database with the nodes converted into the table structure based on the correspondence comprises joining the relational database with the extracted nodes after converting the relational database into graph data.

6. A management computer configured to reference a graph database and a relational database, comprising:
a processor and a memory;
a statistical information management module configured to acquire a reference frequency for each type of node in the graph database;
a high-frequency reference range determination module configured to extract the types of nodes having a reference frequency equal to or more than a threshold, convert the extracted nodes into a table structure, and store the table structure as an intermediate table; and
a query execution module configured to reference the intermediate table based on a received query to the relational database.

7. The management computer according to claim 6, wherein the high-frequency reference range determination module is configured to:
acquire a correspondence between the graph database and the relational database; and
join the relational database with the nodes converted into the table structure based on the correspondence.

8. The management computer according to claim 7, wherein the query execution module is configured to reference, based on the received query to the relational database, the relational database joined with the nodes extracted from the graph database.

9. The management computer according to claim 6, wherein the query execution module is configured to:
convert, when data corresponding to the query to the relational database is not present in the intermediate table, the query to the relational database into a query to the graph database; and
reference the graph database with the converted query to the graph database.

10. The management computer according to claim 7, wherein the high-frequency reference range determination module is configured to join the relational database with the extracted nodes after converting the relational database into graph data.

11. A non-transitory computer-readable storage medium having stored thereon a program for controlling a computer comprising a processor and a memory to execute:
a first procedure of acquiring a reference frequency for each type of node in a graph database;
a second procedure of extracting, by the computer, the types of nodes having a reference frequency equal to or more than a threshold;
a third procedure of converting, by the computer, the extracted nodes into a table structure and storing the table structure as an intermediate table; and
a fourth procedure of referencing, by the computer, the intermediate table based on a received query to a relational database.

12. The non-transitory computer-readable storage medium according to claim 11, wherein the third procedure comprises:
acquiring a correspondence between the graph database and the relational database; and
joining the relational database with the nodes converted into the table structure based on the correspondence.

13. The non-transitory computer-readable storage medium according to claim 12, wherein the fourth procedure comprises referencing, based on the received query to the relational database, the relational database joined with the nodes extracted from the graph database.

14. The non-transitory computer-readable storage medium according to claim 11, wherein the fourth procedure comprises:
converting, when data corresponding to the query to the relational database is not present in the intermediate table, the query to the relational database into a query to the graph database; and
referencing the graph database with the converted query to the graph database.

15. The non-transitory computer-readable storage medium according to claim 12, wherein the joining the relational database with the nodes converted into the table structure based on the correspondence comprises joining the relational database with the extracted nodes after converting the relational database into graph data.
